(19) United States
(12) Patent Application Publication
(10) Pub. No.: US 2014/0145634 A1
(43) Pub. Date: May 29, 2014

(54) CIRCUIT AND METHOD FOR GENERATING A REFERENCE VOLTAGE FOR A POWER CONVERTER

(71) Applicant: TEXAS INSTRUMENTS INCORPORATED, Dallas, TX (US)

(72) Inventors: Timothy Roy Sullivan, Longmont, CO (US); Isaac Cohen, Dix Hills, NY (US)

(73) Assignee: TEXAS INSTRUMENTS INCORPORATED, Dallas, TX (US)

(21) Appl. No.: 13/686,379

(22) Filed: Nov. 27, 2012

(51) Int. Cl. H02M 7/217; H05B 33/08

(52) U.S. Cl. CPC H02M 7/217; H05B 33/0842
USPC 315/201; 363/89

(57) ABSTRACT

Circuits and methods for generating a reference voltage for a power converter control are disclosed herein. The power converter control providing a signal on an output for aligning the voltage and current on a power line so that they are in phase. An embodiment of a circuit includes a voltage detector that detects the voltage on the power line. A signal generator generates a wave that is in phase with voltage on the power line, the wave being generated independent of the voltage on the power line. The output of the signal generator is the reference voltage.

### BACKGROUND

When powering devices, it is ideal to transfer the maximum power to the device. The efficiency to which power is transferred is referred to as the power factor, which ideally has a value of one. When using AC power, the maximum power is transferred when the voltage and current are in phase. In a purely resistive AC circuit, the voltage and current waveforms are in phase (sometimes referred to as being in step) wherein they change polarity at the same instant in each cycle. Therefore, in a purely resistive AC circuit, all the power entering the device is consumed and the power factor is one or close to one.

When reactive loads, such as capacitors or inductors, are present in the device, energy storage in the loads results in a time difference between the current and voltage waveforms. During each cycle of the AC voltage, extra energy, in addition to any energy consumed in the load, is temporarily stored in the load in electric or magnetic fields, and then returned to the power grid a fraction of a portion of the cycle later. This situation results in a lower power factor and inefficient power transfer to the device. In order to overcome the inefficiency, power transferred to the device needs to be increased, which increases the current. Thus, a device with a low power factor will use higher current to transfer the same amount of power than a device with a high power factor.

Power converter circuits improve power factor and drive devices. The power converters have inputs for a line voltage or the like and outputs that are connected to the devices being driven. They have reference voltage inputs wherein the reference voltages are derived from the input and/or output voltage or current. The reference voltage serves as a reference to lock the current and voltage in phase to increase the power factor. If the input voltage fluctuates, the reference voltage will also fluctuate, which may reduce the power factor and cause the power driving the device to fluctuate.

### SUMMARY

Circuits and methods for generating a reference voltage for a power converter control are disclosed herein. The power converter control provides a signal on an output for aligning the voltage and current on a power line so that they are in phase. An embodiment of a circuit includes a voltage detector that detects the voltage on the power line. A signal generator generates a wave that is in phase with voltage on the power line, wherein the wave is generated independent of the voltage on the power line. The output of the signal generator is the reference voltage.

### BRIEF DESCRIPTION OF THE DRAWINGS

FIG. 1 is a block diagram of a power converter that powers a plurality of light-emitting diodes.

FIG. 2 is a graph showing a rectified input voltage of FIG. 1 and a triangular wave generated by the circuit of FIG. 1.

FIG. 3 is a block diagram of an embodiment of the power converter control of FIG. 1.

FIG. 4 is a block diagram of an embodiment of the reference generator of FIG. 1.

FIG. 5 is a flow chart describing a method of operating the circuit of FIG. 1.

FIG. 6 is a flow chart describing a more detailed method of operating the circuit of FIG. 1.

FIG. 7 is a block diagram of another embodiment of the reference generator of FIG. 1.

### DETAILED DESCRIPTION

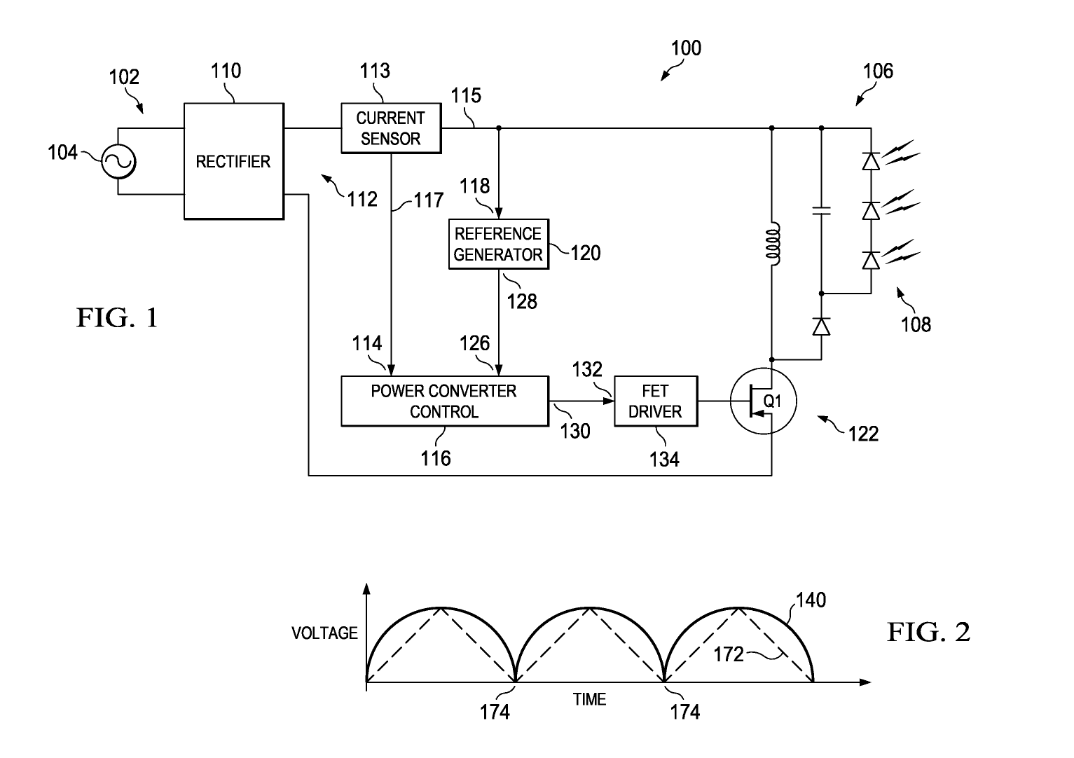

Power factor correction circuits and methods for correcting power factor are described herein. Power factor correction is achieved by shifting the voltage or current of a circuit so that they are in phase. In the examples described herein, power factor correction is performed in a power converter that receives AC line current and drives a plurality of light-emitting diodes (LEDs). An example of a power converter 100 is shown in FIG. 1. The power converter 100 has an input 102 that is connected or connectable to a line voltage 104. The power converter 100 has an output 106 that drives an LED or a plurality of LEDs 108. The line voltage 104 is an AC voltage, such as a 120 volt or 240 volt, 60 Hz or 50 Hz voltage, commonly used as AC line voltages. The LEDs 108 may be of the type commonly used in LED light bulbs.

One of the purposes of the power converter 100 is to make the current at the output 106 in phase with the voltage at the input 102. The closer the output current and input voltage are in phase, the greater the power factor. Power factor correction is provided in the power converter 100 so as to sync the output current with the input voltage so that they are substantially in phase. If the output current and input voltage are not in phase, power is not being transmitted efficiently to the LEDs 108.

Having briefly described the power converter 100 and its purpose, the elements within the power converter 100 will now be described in greater detail. The input 102 is connected to a rectifier 110, which may be a full wave rectifier. The rectifier 110 has an output 112 wherein a current sensor 113 measures or senses the current output from the rectifier 110. The current sensor 113 is on a line that is referred to as the power line 115. The current sensor 113 may have very low resistance so as not to load the output 112 of the rectifier 110. The current sensor 113 has an output that is connected to an input 114 of a power converter control 116 by way of a line 117. The output 112 of the rectifier 110 is also connected to an input 118 of a reference generator 120 and a buck boost driver 122. The power converter control 116 has a reference input 126 that is connected to an output 128 of the reference generator 124. The voltage on the output 128 of the reference generator 120 is referred to as the reference voltage.

The power converter control 116 has an output 130 that is connected to an input 132 of a FET driver 134. The output of the FET driver 134 is connected to a FET Q1, which may be connected to or part of the buck boost driver 122. The output of buck boost driver 122 is the output 106 of the power converter 100.

The rectifier 110 of FIG. 1 is a full wave rectifier. FIG. 2 shows an example of the voltage 140 at the output 112 of the rectifier 110. Because of the rectification, the frequency of the rectified voltage 140 is twice that of the line voltage 104. The rectifier 110 described herein does not have any reactive components, so the voltage 140 is in phase with the line voltage 104. The voltage 140 is output on the power line 115 to the reference generator 120, the buck boost driver 122, and the LEDs 108.

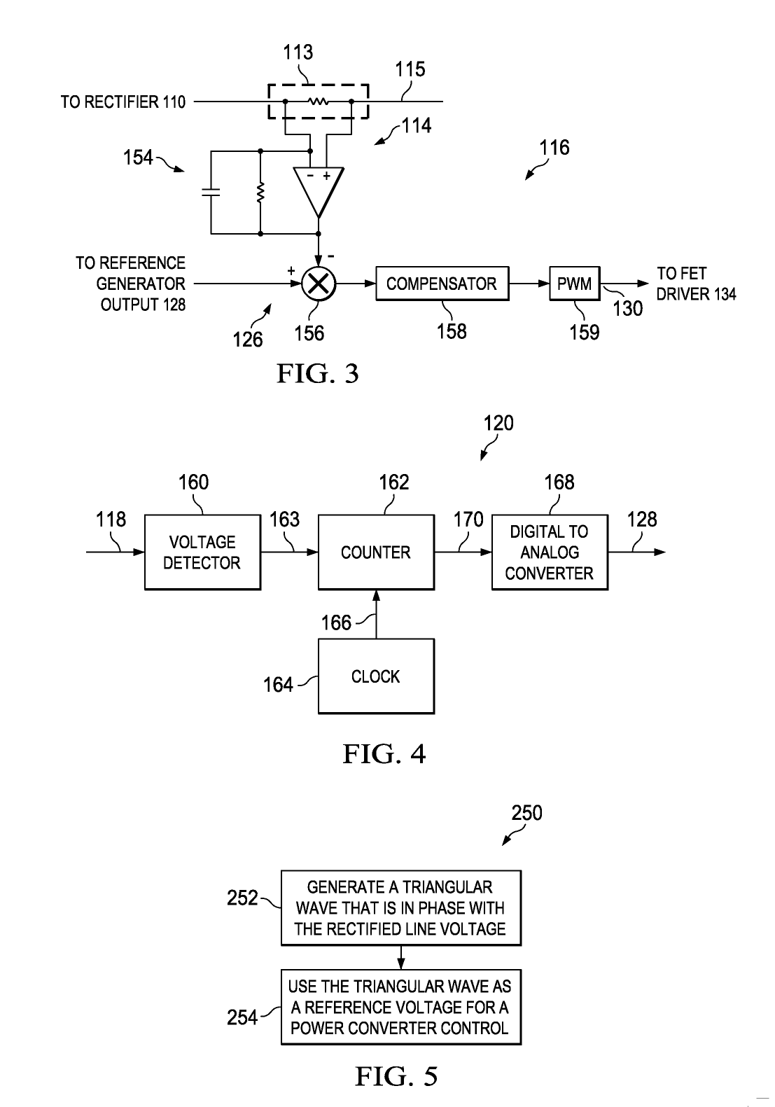

A more detailed block diagram of the power converter control 116 is shown in FIG. 3. The power converter control 116 may be a conventional power converter controller as is well-known in the art. The power converter control 116 has been simplified and may contain other feed back loops that are not shown in FIG. 3 or described herein. The power converter control 116 has the input 114 from the current sensor 113. The current sensor 113 is shown as being a low resistance resistor. It follows that the input 114 receives a voltage that is proportional to the current flow from the rectifier 110 and on the power line 115.

The input 126 of the power converter control 116 is connected to the output 128 of the reference generator 120. In conventional power factor correction circuits, the reference voltage provided at an input similar to the input 126 is connected to the voltage at the LEDs 108. As described in greater detail below, the voltage across the LEDs 108 is constant because it is the combined forward voltage of the LEDs 108. The reference voltage supplied to the input 126 in the power converter 100 described herein is a triangular wave that is in phase with the line voltage 104.

The power converter control 116 has a current measuring circuit 154 that measures the current at the input 114. More specifically, the current measuring circuit scales the voltage on the input 114 by the use of an amplifier. A voltage generated by the current sensing circuit 154 is added to the reference voltage from the input 124 by a summer 156. The resulting signal is compensated by a compensator 158 and used to drive a pulse width modulator 159. The output of the pulse width modulator 259 is the output 130 of the power converter control 116 and is connected to the FET driver 134.

Referring again to FIG. 1, the reference generator 120 provides the reference voltage to the input 126 of the power converter control 116. Unlike conventional reference voltages, the reference generator 120 drives the power converter control 116 with a triangular waveform that is in phase with the rectified voltage 140. A block diagram of an embodiment of the reference generator 120 is shown in FIG. 4. The input 118 is connected to a voltage detector 160. The voltage detector 160 may detect when a predetermined voltage is present on the input 118 or it may measure the voltage on the input 118. The output of the voltage detector 160 is connected to a counter 162 by way of a line 163. The voltage detector 160 transmits a signal to the counter 162 by way of the line 163 that causes the counter 162 to start counting as described in greater detail below.

A clock 164 has an output that is connected to the counter 162 by way of a line 166. The counter 162 counts based on the clock signals output from the clock 164 and may count incrementally and decrementally as described in greater detail below. The counter 162 outputs numbers, such as binary numbers, to a digital to analog converter (DAC) 168 by way of a line 170. The DAC 168 converts the numbers output by the counter 164 to analog signals. The DAC 168 may also smooth or filter the analog signal as is well-known in the art.

Having described the components of the reference generator 120, its operation will now be described. The reference generator 120 generates a triangular wave 172, FIG. 4, that is output on the output 128. The triangular wave 172 is used as the reference voltage on the input 126 for the voltage converter 116. As shown in FIG. 2, the triangular wave 172 is in phase with the voltage 140. The use of a triangular wave significantly increases the power factor with respect to the line voltage 102 and the current driving the LEDs 108. More specifically, the triangular wave 172 provides a current reference for the power converter control 116 that is always in phase with the line voltage 102. In addition, a triangular wave is very efficient to generate relative to a sine wave and significantly follows the rectified voltage 140. It is noted that waves other than triangular waves may be used as the reference voltages. For example, a sine wave or ramps may be used.

The voltage 140, FIG. 2, is input to the reference generator 120 at the input 118. In the present embodiment, the voltage 140 is analyzed by the voltage detector 160. The voltage detector 160 generates a signal on the line 163 when the voltage 140 is at a predetermined value. In the simplest embodiment, the voltage detector 140 outputs a voltage on the line 163 when the voltage 140 is at its lowest value, which is when the voltage 140 is between cycles. This value is shown on FIG. 4 as the low voltage 174. For example, when the voltage 140 is at the transition between cycles, it is at the low voltage 174, which may be zero volts unless a DC offset has been applied to the voltage 140. When the voltage detector 160 detects the low voltage 174, it may output a reset signal to the counter 162 by way of the line 163.

When the counter 162 receives the signal on the line 163, it starts counting based on clock pulses received on the line 166 from the clock 164. The clock 164 is set to output a predetermined number of pulses for each cycle of the voltage 140. For example, the clock 164 may be set to output 256 pulses for each cycle of the voltage 140. With a 60 Hz line voltage 102, the voltage 140 has a frequency of 120 Hz, which is a period of approximately 8.3 mS. Therefore, the clock frequency is approximately 30.7 kHz.

In order to generate the triangular wave 170, the counter 162 starts counting incrementally for the first half of the cycle of the voltage 140. In the embodiment described above, the counter 162 counts incrementally for the first 128 pulses. The counter 162 then counts down for the following 128 pulses. The numbers generated by the counter 162 are transmitted to the DAC 168 by the line 170. When the voltage 140 has reached its low voltage 174 between cycles, the voltage detector 160 transmits a signal, such as a reset signal, to the counter 162, which sets the counter to zero or other predetermined number corresponding to the low voltage 174 between cycles. If the voltage 140 has not fluctuated, the number generated by the counter 162 will be at the starting number when the voltage 140 reaches the low voltage 174. If, however, the voltage 140 has fluctuated, resetting the counter 162 enables the next cycle of the triangular wave 172 to be in phase with the voltage 140.

The DAC 168 converts the numbers generated by the counter 162 to an analog signal. As described above, the numbers increment for half a cycle of the voltage 140 and then decrement for the other half of the cycle. Therefore, the analog signal is the triangular wave 172, FIG. 2. It is noted that the DAC 168 may filter the analog signal to smooth it to remove the effects of the digital to analog conversion. As described above, the combination of the counter 162 and the DAC 168 generate the triangular wave 172 and are sometimes referred to as the signal generator.

Because the triangular wave 172 is started at the low voltage 174 point of the voltage 140, the triangular wave 172 is in phase with the voltage 140. As stated above, the rectifier 110 appears to be a resistive load to the line voltage 102. Therefore, the voltage 140 is in phase with the line voltage 102, which means that the triangular wave 172 is in phase with the line voltage 102. The triangular wave 172 is generated independent of the voltage 140, meaning that the voltage 140 is only used as a starting reference for the triangular wave 172. The triangular wave 172 is used as the reference voltage for the power converter control 116. Because the triangular wave 172 is generated independent of the voltage 140, other than the low voltage 174 as a reference, the triangular wave 172 is always in phase with the voltage 140. It follows that the triangular wave 172 is always in phase with the line voltage 102 because the rectifier 110 is a resistive load.

Referring again to FIG. 1, the power converter control 116 outputs a pulse width modulated signal to the FET driver 134. The FET driver 134 may be a driver as is well-known in the art for driving a FET. The FET driver 134 drives the FET Q1 with a signal based on the difference between the current sensed by the current sensor 113 and the reference voltage so as to make the voltage and current on the power line 113 in phase. The FET Q1 drives the buck boost driver 122, which in turn drives the LEDs 108. The voltage across the LEDs 108 is substantially constant because it is the forward voltage of the LEDs 108. Therefore, only the current supplied to the LEDs 108 will fluctuate. It is noted that the current driving the LEDs 108 was sensed by the current sensor 113 and is maintained in phase with the line voltage 102 as described above. Therefore, the power factor is substantially close to one. In many circumstances, a power factor of 0.992 has been achieved. In addition to the high power factor, the triangular wave 172 does not fluctuate, so the total harmonic distortion is very low. In many circumstances, the total harmonic distortion has been measured to be as low as 11.89%.

The operation of the power converter 100 described above can be described with regard to the flow chart 250 of FIG. 5. In step 252, the triangular wave that is in phase with the rectified voltage 104 is generated. The power converter 100 generates the triangular wave 172 by monitoring the rectified voltage 140 and using the counter 162 and the DAC 168 as a signal generator to generate the triangular wave 172. At step 254, the triangular wave is used as a reference voltage for the power converter control 116. The output of the DAC 168 is the reference voltage that is output to the reference input 126 of the power converter controller 116.

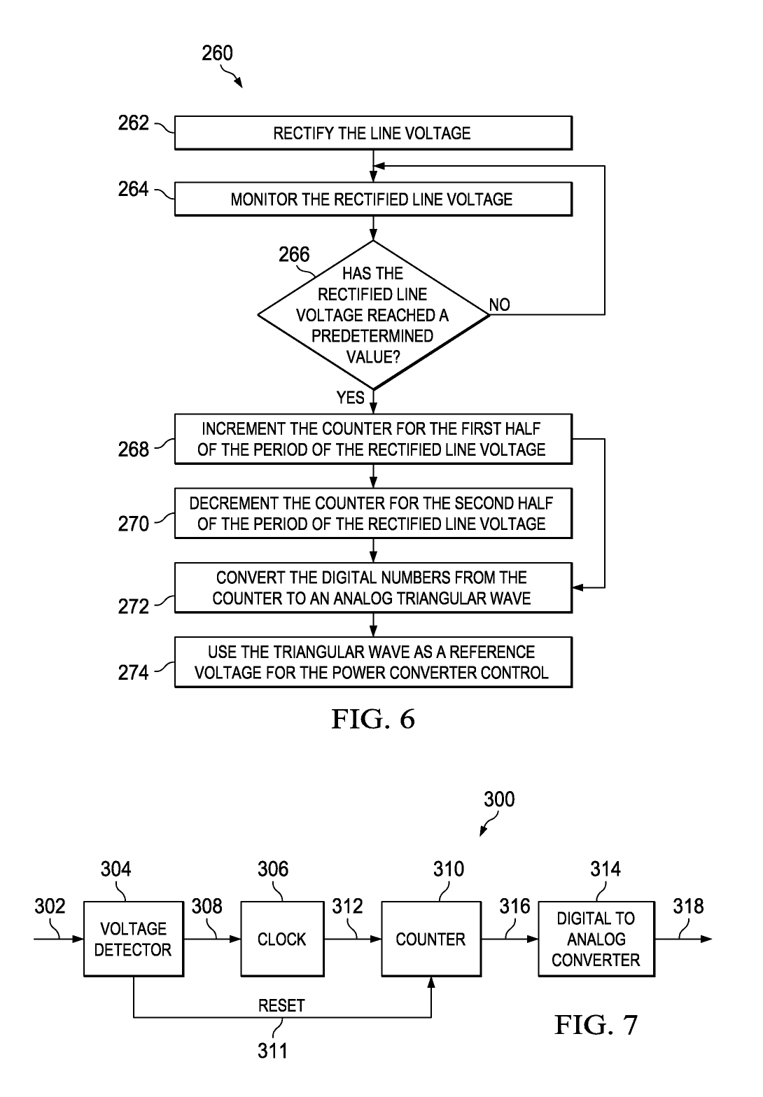

A more detailed flow chart 260 describing the method for driving the LEDs 108 is shown in FIG. 6. The method commences with rectifying the line voltage 102 as described in step 262. The rectification is full wave rectification to yield the voltage 140 of FIG. 2. In step 264, the voltage 140 is monitored, which may be achieved by the voltage detector 160 within the reference generator 120. The detector 160 may detect when the voltage 140 reaches a specific voltage level. In the embodiments described herein, detection occurs when the voltage 140 reaches the low voltage 174. However, detection could also occur at the peak of the voltage 140. While other voltage levels may be used, they are more difficult in that they occur twice during each cycle.

Decision block 266 determines if the detected voltage has reached a predetermined value. In the embodiments described above, the predetermined value is the low voltage 174 of zero volts. However, the detected voltage could be any predetermined value. If the predetermined voltage has not been detected, processing returns to step 264 to continue monitoring the rectified line voltage.

If the predetermined voltage has been detected, processing proceeds to step 268 where the counter 162 incrementally counts for the first half of the cycle of the voltage 140. The counting is performed independent of the line voltage 102. Therefore, fluctuations in the line voltage 102 will not affect the numeric values generated by the counter 162. In step 270 the count is decremented for the second half of the cycle of the voltage 140. Again, this count is performed independently of the line voltage 102 so that fluctuations in the line voltage 102 will not affect the numbers generated by the counter 162.

The DAC 168, at step 272, converts the numbers generated by the counter 162 to an analog signal, which is the triangular waveform 174. Because the counting incremented during the first half of the cycle of the voltage 140 and decremented during the second half of the cycle of the voltage 140, the triangular wave 174 is symmetric, even if the voltage 140 is not symmetric or if it fluctuates. The triangular wave 174 is used as a reference voltage for the power converter control 116 in step 274. Because the triangular wave 174 is independent of the line voltage 102, but in phase with the line voltage 102, the power factor of the power converter 100 is greater than conventional circuits where a sine wave that is dependent on the line voltage 102 is used as the reference voltage.

Having described some embodiments of the power converter 100 and methods for generating a reference voltage, other embodiments of the power converter 100 and methods will now be described.

In some embodiments, the frequency of the line voltage 102 may fluctuate or the power converter 100 may be used in regions that have different line voltage frequencies. For example, common line voltage frequencies are 50 Hz and 60 Hz, but they can fluctuate. The power converter 100 may measure the period of the rectified voltage 140 to determine the amount of time needed for the increment counting and the decrement counting. In one embodiment, the time between the low voltages 174 is measured. This time is then divided by the period of the clock pulse to calculate the number of pulses generated during a cycle of the voltage 140. Half of this number is used for the increment counting and half is used for the decrement counting.

The power converter 100 has been described as using a digital counter 162 and a DAC 168 to generate the triangular wave 172. Other well-known methods of generating a triangular wave may be used instead of the counter 162 and the DAC 168. For example, a signal generator generating a triangular waveform may be used. The alternative circuit used to generate the triangular wave 172 may be connected to the voltage detector 160 to lock the phase of the voltage 140 to the phase of the triangular wave 172. In some embodiments, a sine wave or rectified sine wave that is independent of the line voltage 102, but in phase with the line voltage 102 may be used. However, sine wave generation is more costly than triangular wave generation.

Another embodiment to the reference generator 120 is shown by a block diagram of a reference generator 300 shown in FIG. 7. The reference generator 300 provides the reference voltage to the input 126 of the power converter control 116 in the same manner as the reference generator 120, but it uses a slightly different circuit and method. The reference generator 300 has an input 302 that is connected to a voltage detector 304. The voltage detector 304 operates in substantially the same way that the voltage detector 160 operates. The output of the voltage detector 304 is connected to a clock 306 by way of a line 308. The voltage detector 304 transmits a signal to the clock 306 by way of the line 308 as described in greater detail below.

The clock 306 has an output that is connected to a counter 310 by way of a line 312. The counter 310 counts based on the clock signals output from the clock 306 in the same way that the clock 162 counts. A reset line 311 is connected from the voltage detector 304 to the counter 310 wherein the reset line 311 resets the counter 310 to a predetermined number, such as zero. The counter 310 outputs numbers, such as binary numbers, to a digital to analog converter (DAC) 314 by way of a line 316. The DAC 314 converts the numbers output by the counter 310 to analog signals in the same way that the DAC 168 converts numbers to an analog signal and may also smooth or filter the analog signal. The analog signal is output on a line 318, which is the reference voltage for the power converter control 116.

Having described the components of the reference generator 300, its operation will now be described. The reference generator 300 generates the triangular wave 172, FIG. 4, that is output on the output 318. The voltage 140, FIG. 2, is input to the reference generator 300 at the input 302. In the present embodiment, the voltage 140 is analyzed by the voltage detector 304. The voltage detector 304 generates a signal on the line 308 when the voltage 140 is at a predetermined value. For example, when the voltage 140 is at the transition between cycles, it is at the low voltage 174, which is zero volts unless a DC offset has been applied to the voltage 140. When the voltage detector 304 detects the low voltage 174, it may also output a reset signal to the counter 310 on the line 311.

The signal on the line 308 causes the clock 306 to generate clock pulses that are output on the line 312. The clock 306 is set to output a predetermined number of pulses for each cycle of the voltage 140 as with the clock 164. When the counter 310 receives the clock signal, it starts counting in the same manner as the counter 166. When the reset signal is sent on the line 311, the clock 310 resets. The reset signal may correspond to the detection of a low voltage level 174. The DAC 314 converts the numbers generated by the counter 310 to an analog signal in the same way the DAC 168 converted numbers to an analog signal. The output of the DAC 314 is the reference voltage and is input to the power converter control 116.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A circuit for generating a reference voltage for a power converter control, the power converter control syncing the phase the voltage and current on a power line, the power converter control having an input for the reference voltage and an output, the circuit comprising:
a voltage detector that detects the voltage on the power line; and
a signal generator that generates a wave that is in phase with the voltage on the power line, the wave being generated independent of the voltage on the power line;
wherein the output of the signal generator is the reference voltage.

2. The circuit of claim 1, wherein the voltage on the power line is a rectified sine wave and wherein the voltage detector detects the low voltage between cycles of the rectified sine wave.

3. The circuit of claim 2, wherein the signal generator commences generating the wave when the voltage detector detects the low voltage between cycles of the rectified sine wave.

4. The circuit of claim 1, wherein the voltage on the power line is a rectified sine wave; wherein the voltage detector detects the low voltage between cycles of the rectified sine wave; and wherein the signal generator generates a triangular wave commencing when the voltage detector detects the low voltage between cycles.

5. The circuit of claim 1, wherein the signal generator comprises:
a counter that generates numbers when the voltage detector detects a predetermined voltage; and
a digital to analog converter that converts the numbers generated by the counter to an analog signal, the analog signal being the reference voltage.

6. The circuit of claim 5, wherein the counter incrementally counts for a first half of a cycle of the voltage on the power line and decrementally counts for the second half of the cycle of the voltage on the power line.

7. The circuit of claim 1, wherein:
the voltage on the power line is a rectified sine wave;
the voltage detector detects the low voltage between cycles of the rectified sine wave; and
the signal generator comprises:
a counter that commences counting upon the voltage detector detecting the low voltage, the counter incrementally counting for the first half of a cycle of the voltage on the power line and decrementally counting during the second half of the cycle, the counting generating numbers; and
a digital to analog converter that converts the numbers generated by the counter to an analog signal, the analog signal being a triangular wave.

8. A method for providing a reference voltage to a power converter control, the power converter control providing a signal on an output for aligning the voltage and current on a power line so that they are in phase, the method comprising:
monitoring the voltage on the power line to detect a predetermined voltage;
generating the reference voltage upon detection of the predetermined voltage, the reference voltage being in phase with the voltage on the power line, and the reference voltage being generated independent of the voltage on the power line.

9. The method of claim 8, wherein the voltage on the power line is a rectified sine wave and wherein the predetermined voltage is the low voltage between cycles of the rectified sine wave.

10. The method of claim 8, wherein the generating comprises generating a triangular wave.

11. The method of claim 10, wherein the triangular wave has a low voltage point that occurs at the same time as the predetermined voltage.

12. The method of claim 8, wherein the generating comprises:
starting a counter upon detection of the predetermined voltage;
counting incrementally for a period of the first half of a cycle of the voltage on the power line;
counting decrementally for a period of the second half of the cycle of the voltage on the power line; and
converting numbers generated by the counter to an analog signal.

13. The method of claim 12 and further comprising smoothing the analog signal.

14. The method of claim 12 and further comprising measuring the period of a cycle of the voltage on the power line.

15. A circuit for driving a light-emitting diode (LED), the circuit comprising:
an input, wherein an input voltage is receivable on the input;
a power converter control connected to the input, wherein the power converter syncs the input voltage with an output current to the LED, the power converter having a reference voltage input; and
a reference generator for generating the reference voltage, the reference voltage being connected to the reference voltage input of the power converter control;
wherein the reference voltage generated by the reference generator is substantially in phase with the input voltage.

16. The circuit of claim 15, wherein the reference voltage is substantially triangular.

17. The circuit of claim 15, wherein the reference generator comprises a voltage detector to monitor the input voltage and wherein the reference generator generates the reference voltage based on the monitored input voltage.

18. The circuit of claim 15 and further comprising a driver connected between the LED and the power converter control, the driver generating current to drive the LED.

19. The circuit of claim 1 and further comprising a rectifier wherein the input to the rectifier is a sinusoidal voltage and the output of the rectifier is the input voltage.

20. The circuit of claim 15 wherein the reference generator comprises:
a counter that starts incrementally counting during the first half of a cycle of the input voltage and decrementally counting during the second half of a cycle of the input voltage; and
a digital-to-analog converter connected to the output of the counter, the output of the digital to analog converter being the reference voltage.
